(19) United States
(12) Patent Application Publication
(10) Pub. No.: US 2026/0210467 A1
(43) Pub. Date: Jul. 23, 2026

(54) ARRANGEMENT WITH A CONNECTING PIECE FASTENED TO A HOSE

(71) Applicant: HC-Kunststoffwerk Rülzheim GmbH, Rülzheim (DE)

(72) Inventor: Andreas HAMBURGER, Rülzheim (DE)

(21) Appl. No.: 19/455,059

(22) Filed: Jan. 21, 2026

(30) Foreign Application Priority Data
Jan. 22, 2025 (DE) 202025100320.1

(51) Int. Cl. F16L 33/213; F16L 33/01

(52) U.S. Cl. CPC F16L 33/213; F16L 33/01

(57) ABSTRACT

An arrangement with a connecting piece fastened to a hose is provided. The connecting piece has a coupling part partially inserted into the hose and a connecting part located outside the hose. There is a profiling on the outer jacket surface of a first region of the coupling part, which is configured to be located in the hose. Furthermore, there is a profile element in a second region of the coupling part, which is configured to be located outside the hose. To fasten the connecting piece to the hose, there is an overmolded mass which encloses the profile element in the second region of the coupling part. The coupling part extends over a region of the hose which is adjacent thereto, wherein the overmolded mass is present on the outer jacket surface of the hose and on the end face thereof facing the profile element.

This application claims priority from German Patent Application No. DE 20 2025 100 320.1 filed Jan. 22, 2025, the disclosure of which is incorporated by reference herein in its entirety for all purposes.

The present disclosure relates to an arrangement with a connecting piece fastened to a hose

Such Arrangements Are Used to Transport Gaseous or Liquid Media.

The design of such an arrangement is such that the connecting piece comprises a connecting part and a coupling part. The coupling part is inserted into the hose and fixed in place, thus coupling the connecting piece to the hose. The design of the connecting part is independent of the design of the coupling part and can, in particular, form an interface to external units. An example of such a connecting part is a plug.

The connecting piece generally has a channel running through it in the longitudinal direction. A medium conveyed in the hose is then fed to an external unit through the channel of the connecting piece.

A typical application example is the conveyance of a cooling medium, in particular a cooling liquid, which is conveyed via the hose and the connecting piece. This arrangement is used to cool electronic components in particular.

A further application example is the conveyance of a cleaning medium, in particular a cleaning liquid, which is conveyed via the hose and the connecting piece. This arrangement is used for the cleaning of assemblies, in particular optical assemblies.

The arrangements formed in this way can be used in various industrial applications, for example in the automotive sector.

Typically, the connecting piece is fixed to the hose simply by pressing the coupling part into the hose.

Although the method can be carried out easily and cost-effectively, the long-term stability of the connection between the connecting piece and hose is often insufficient.

An even more serious problem is that the interface between the coupling part and the hose is not completely sealed, so that liquid or gaseous medium can escape there, which hinders or even renders impossible the use of the connecting parts in the respective application.

It is also known to additionally fix the hose to the coupling part by means of a clamp. This requires an additional mechanical part, which also increases the assembly effort. In addition, a clamp does not adequately seal the interface between the hose and the coupling part.

The object of the present disclosure is to provide an arrangement of the type mentioned at the beginning, in which there is a long-term stable and tight connection between the connecting piece and the hose.

The features of claim 1 are intended to provide a solution to this object. Advantageous embodiments and appropriate further developments are described in the dependent claims.

The present disclosure relates to an arrangement with a connecting piece fastened to a hose, wherein the connecting piece has a coupling part that can be partially inserted into the hose and a connecting part located outside the hose. There is a profiling on the outer jacket surface of the coupling part region located in the hose. There is a profile element outside the coupling part region located in the hose. To fasten the connecting piece to the hose, there is an overmolded mass which encloses the profile element in the coupling part region located outside the hose, and which extends over the hose region adjacent thereto. In addition, the overmolded mass is present on the outer jacket surface of the hose and the end face of the hose facing the profile element.

The arrangement according to the present disclosure can be used to transport gaseous or liquid media, wherein the connecting piece generally has a channel running through it in the longitudinal direction. The medium is then conveyed through the cavity of the hose and the channel of the connecting piece.

To fasten the hose to the connecting piece, the hose is fitted onto the coupling part of the connecting piece, wherein the flexible hose expands slightly as a result.

To ensure continuous fault-free transport of the medium in the arrangement, it is advantageous if the internal diameter of the hose corresponds at least approximately to the internal diameter of the channel of the connecting piece. The internal diameter of the channel of the connecting piece may be constant.

According to the present disclosure, the connecting piece is coupled to the hose by means of an overmolded mass, which is applied to the arrangement in an overmolding process.

Here, the coupling part of the connecting piece is initially only partially inserted into the coupling part of the hose.

To fasten the connecting piece to the hose, the overmolded mass is applied to the coupling part region located outside the hose and the hose region adjacent thereto.

This not only ensures a firm coupling between the coupling part and the hose, but also provides a seal to the outside.

According to the present disclosure, there is a profiling on the outer jacket surface of the coupling part region located in the hose. Furthermore, there is a profile element in the coupling part region located outside the hose.

The profiling ensures a good mechanical hold of the hose on the coupling part.

According to an advantageous embodiment, the profiling of the coupling part has at least one profile structure forming an elevation, which profile structure effects a mechanical fixation of the hose.

In particular, the or each profile structure is ramp-shaped, the incline of which is smaller at the coupling part in the fitting direction of the hose than in the opposite direction.

In the fitting direction, the hose can thus be fitted relatively easily along the flat incline of the ramp of the or each profile structure onto the coupling part. However, considerably more force is required to pull the hose off the coupling part against the high incline of the ramp of the or each profile structure.

The profile element according to the present disclosure is located at a distance from the profile structure and is advantageously formed in the shape of an annular elevation, i.e., the profile element projects beyond the advantageously rotationally symmetrical jacket surface of the coupling part.

It is important that the hose be only fitted onto the profiling, not onto the profile element.

The overmolded mass is then overmolded onto the region of the outer jacket surface of the hose, which region is fitted onto the coupling part. In addition, the exposed part of the coupling part, which exposed part is adjacent thereto and on which there is also located the profile element, is overmolded with the overmolded mass so that the profile element is completely overmolded with overmolded mass.

This significantly improves the hold of the hose on the coupling part. Further mechanical elements, such as a clamp, are not required to fix the hose in place.

Furthermore, a good sealing effect is achieved with the overmolded mass.

Advantageously, a thermoplastic is used as the overmolded mass, which thermoplastic has a good adhesive and sealing effect, in particular due to its somewhat sticky consistency.

The overmolded mass seals not only the outer jacket surface but also the end face of the hose and also the seams between the hose and the coupling part in the region of the end face of the hose.

This effectively prevents gaseous or liquid media from escaping in the region of the end face of the hose.

In particular, the penetration of gaseous or liquid media between the layers of the hose is also prevented in a multi-layer hose, so that swelling of the hose is prevented. This is because the overmolded mass extends not only over the seam between the hose and the coupling part, but also over the entire end face of the hose, where the layers of the hose are exposed.

According to a particularly advantageous embodiment, the multi-layer hose is fitted onto the coupling part in such a way that its inner layer, which lies directly on the coupling part, projects over the edge of the hose and is overmolded with the overmolded mass.

This is achieved by fitting the flexible, multi-layer hose slightly beyond its target position onto the coupling part by widening the hose. The hose is then carefully retracted a little until it is in the target position. The inner layer of the hose, which rests under tension directly against the coupling part, remains in its position, i.e. only the outer layers of the hose are retracted so that the inner layer of the hose projects slightly beyond the edge of the hose, which edge is formed by the remaining layers. The overmolded mass is then applied to the coupling part region located outside the hose and to the outer jacket surface of the hose region adjacent thereto. In this process, overmolded mass is also applied directly to the region of the segment of the inner layer of the hose, which segment projects over the edge of the hose, thereby achieving a particularly good seal at the seam between the coupling part and the hose.

According to an advantageous variant of the present disclosure, the or each profile structure has a cross section that is uniform in the circumferential direction.

Each profile structure forms a structure which is closed in the circumferential direction.

The profile structures thus form a barrier that prevents the migration of gaseous or liquid media between the hose and the coupling part to a certain extent.

According to a further variant of the present disclosure, the profiling forms a continuous channel structure between the coupling part and the hose, which channel structure opens out at the edge of the hose.

Since the channel structure opens out at the edge of the hose and forms a continuous structure inside the hose, the entire channel structure can be filled with overmolded mass during injection molding when the overmolded mass is injected.

This not only further improves the hold of the hose on the coupling part. Rather, the surface between the hose and the coupling part is also sealed with the overmolded mass, whereby the gaseous or liquid medium is prevented from getting between the hose and the coupling part due to creep effects. This prevents the medium from escaping and also protects the hose from damage.

The prerequisite for this is a sufficiently large dimensioning of the diameter of the coupling part and, furthermore, a flexibility of the hose such that the channels of the channel structure remain unobstructed after fitting the hose onto the profile structure of the coupling part.

Advantageously, the channel structure has at least one channel segment running in the longitudinal direction of the coupling part, which channel segment opens out at the edge of the hose.

In particular, the channel segment runs parallel to the longitudinal axis of the coupling part.

As these channel segments lie in the direction the overmolded mass was injected, they can be easily filled with overmolded mass.

In order to achieve a sealing effect over the entire circumference of the coupling part or, respectively, the hose, at least one further channel segment running in the circumferential direction of the coupling part opens out at the channel segment(s) running in the longitudinal direction.

The further channel segment is particularly advantageously formed in the shape of a ring.

This results in a branched, cross-linked channel structure that extends advantageously over the entire circumference of the coupling part and thus ensures a flat seal with the overmolded mass introduced there.

This sealing effect can be further increased if there are multiple further channel segments running in the circumferential direction of the coupling part, which channel segments are arranged at a distance from each other in the longitudinal direction of the coupling part.

This results in a cross-linked channel structure over a large part of the coupling part, so that the overmolded mass injected there creates a large-area seal.

According to an advantageous further development, the channel structure has multiple channel segments running offset in the longitudinal direction of the coupling part, which channel segments are connected by at least one further channel segment running in the circumferential direction of the coupling part.

According to an advantageous further development, a connecting piece is fastened to both ends of the hose.

This creates a firmly connected assembly that, together with the hose and the connecting pieces mounted at its ends, enables a connection to external units. For example, the connecting parts can form plugs.

Advantageously, this arrangement can be further developed in such a way that a component is present on one or each connecting piece.

The components can be formed by valves or containers, for example. The components can be directly and non-detachably connected to the connecting pieces.

The coupling parts of the connecting pieces at both ends of the hose may be formed identically. Each coupling part has the design according to the present disclosure with a profile element, wherein the region of the coupling part with the profile element and the adjacent region of the hose are enclosed by the overmolded mass.

The invention is explained below on the basis of the drawings.

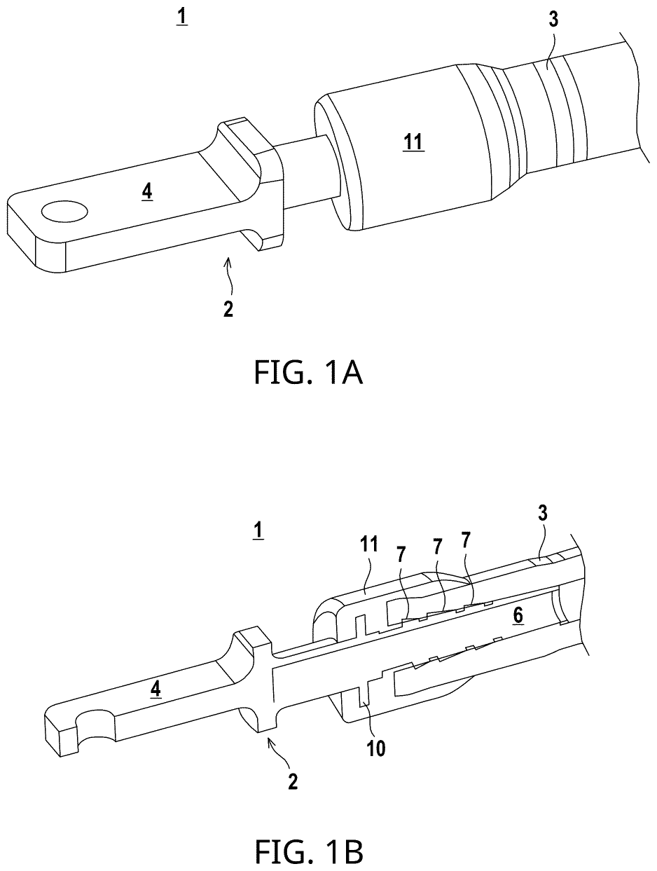

FIGS. 1A-B: First exemplary embodiment of the arrangement according to the present disclosure with a connecting piece and a hose in a perspective view and a sectional view.

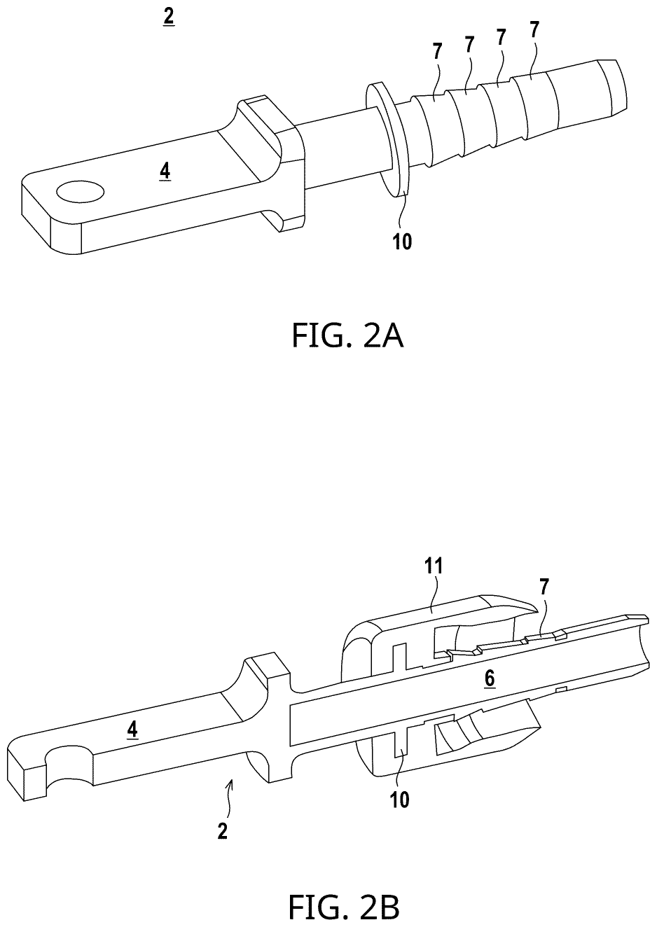

FIG. 2A: Single view of the connecting piece of the arrangement shown in FIGS. 1A-B.

FIG. 2B: Single view of the connecting piece with overmolded mass of the arrangement shown in FIGS. 1A-B.

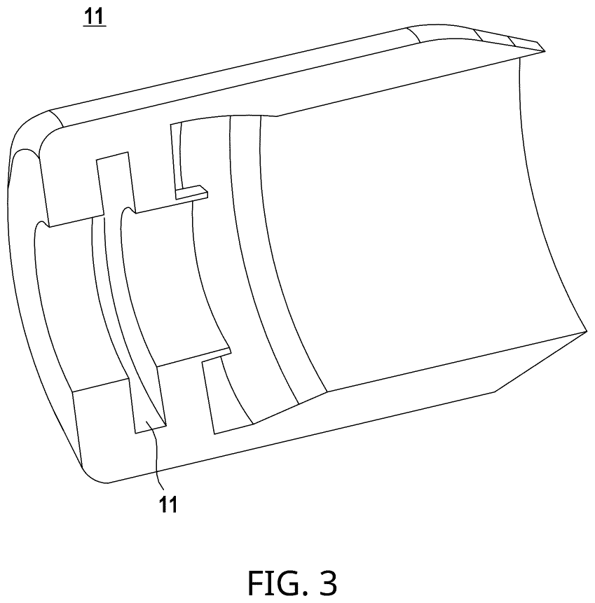

FIG. 3: Single view of the overmolded mass of the arrangement shown in FIGS. 1A-B.

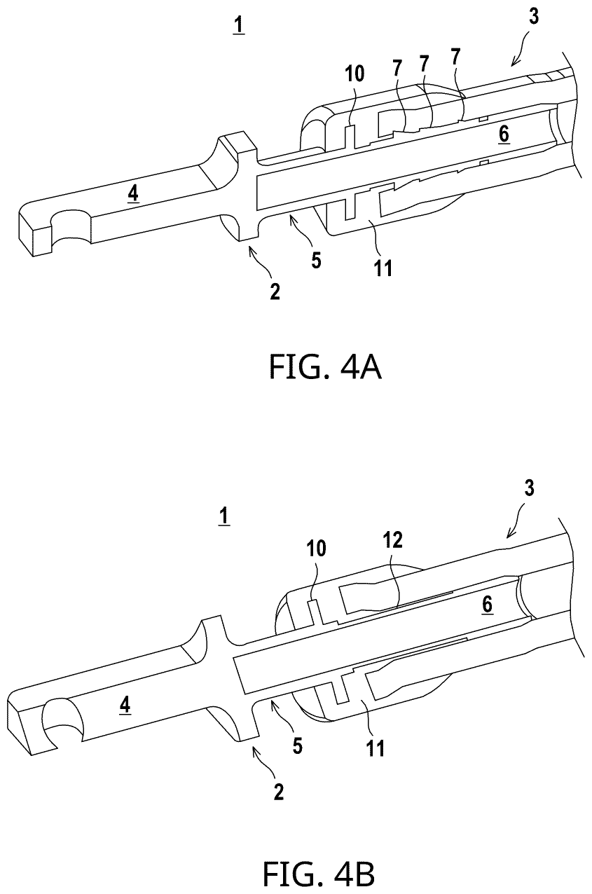

FIGS. 4A-B: Second exemplary embodiment of the arrangement according to the present disclosure with a connecting piece and a hose in a first sectional view and a second sectional view.

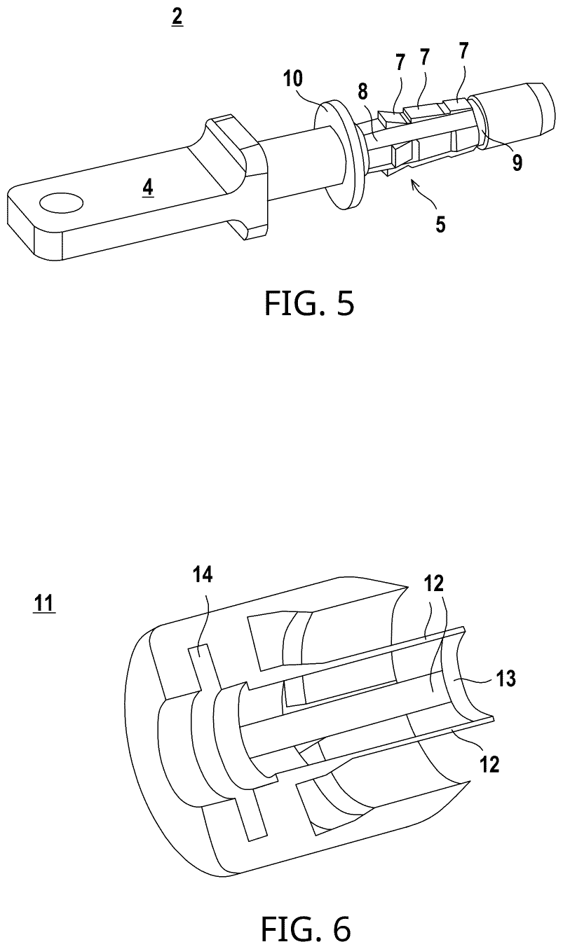

FIG. 5: Single view of the connecting piece of the arrangement shown in FIGS. 4A-B.

FIG. 6: Single view of the overmolded mass of the arrangement shown in FIGS. 4A-B.

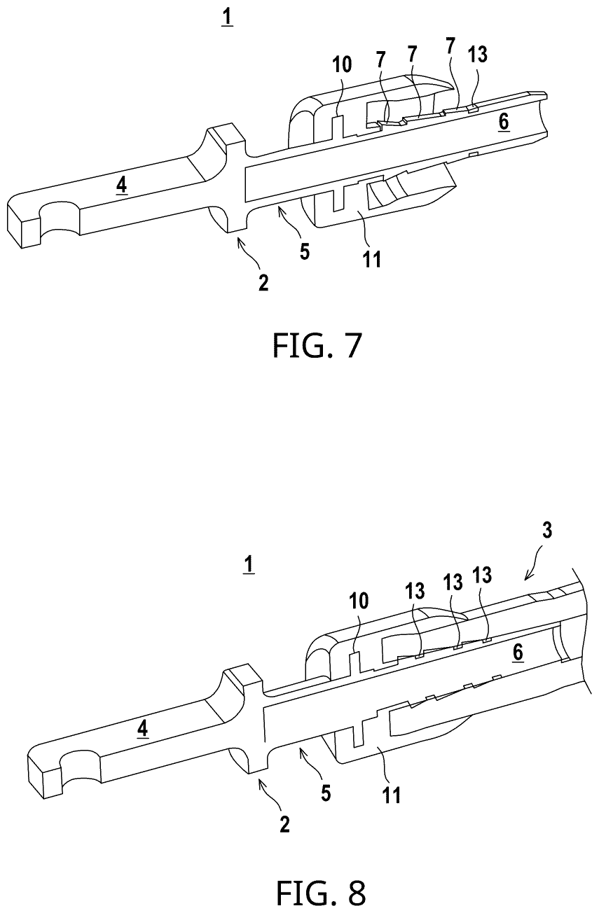

FIG. 7: Single view of the connecting piece with overmolded mass of the arrangement shown in FIGS. 4A-B.

FIG. 8: Further exemplary embodiment of the arrangement according to the present disclosure.

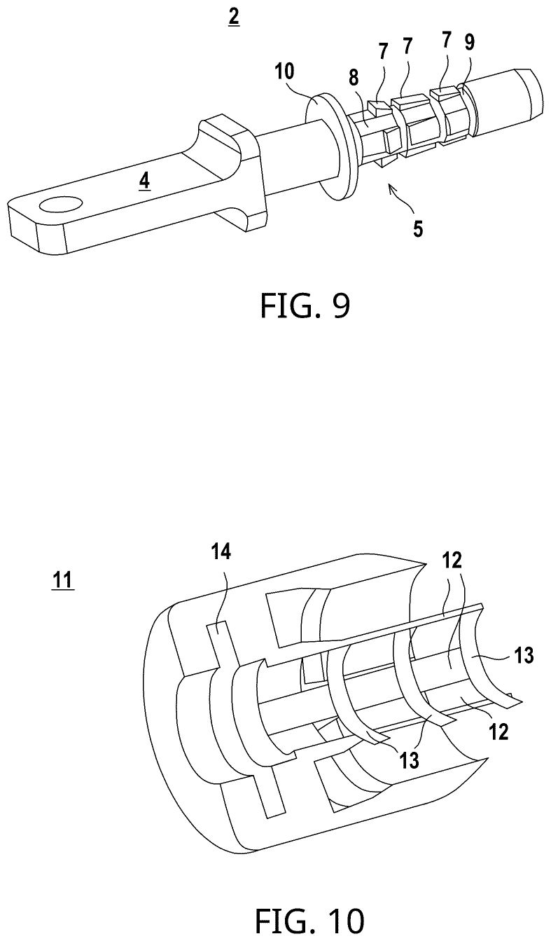

FIG. 9: Single view of the connecting piece of the arrangement shown in FIG. 8.

FIG. 10: Single view of the overmolded mass of the arrangement shown in FIG. 8.

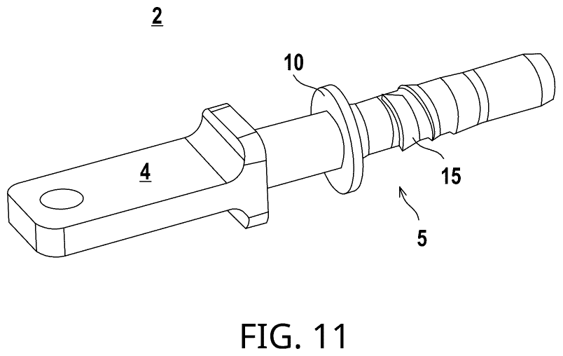

FIG. 11: Further exemplary embodiment of a connecting piece of the arrangement according to the present disclosure.

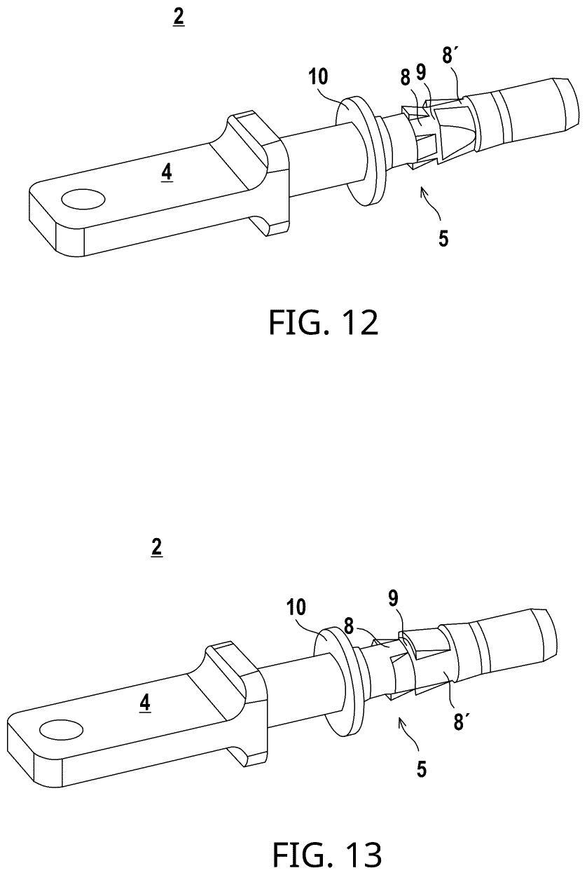

FIG. 12: Further exemplary embodiment of a connecting piece of the arrangement according to the present disclosure.

FIG. 13: Further exemplary embodiment of a connecting piece of the arrangement according to the present disclosure.

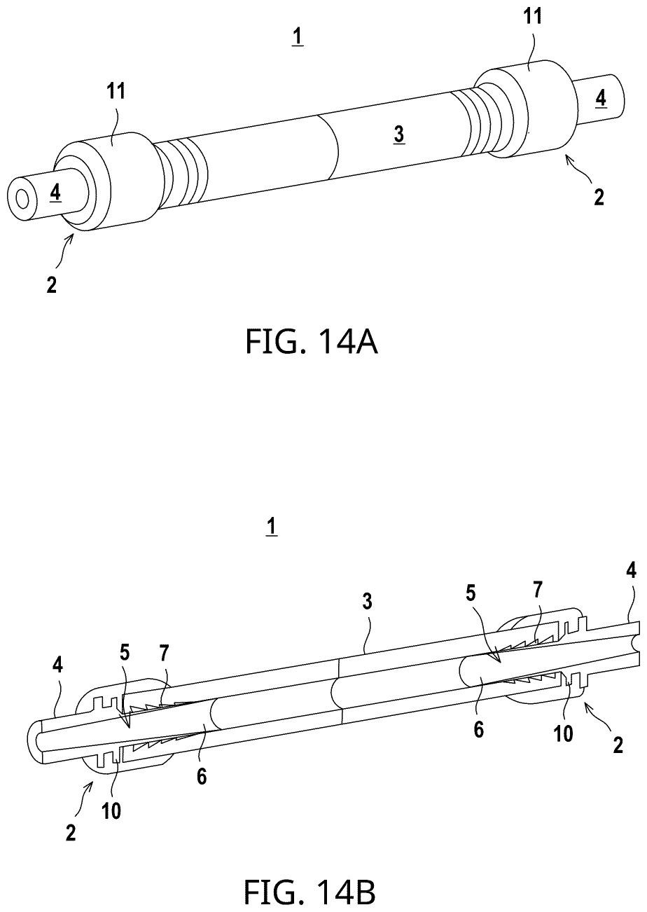

FIGS. 14A-B: First exemplary embodiment of an arrangement with two connecting pieces on a hose in a perspective view and a sectional view.

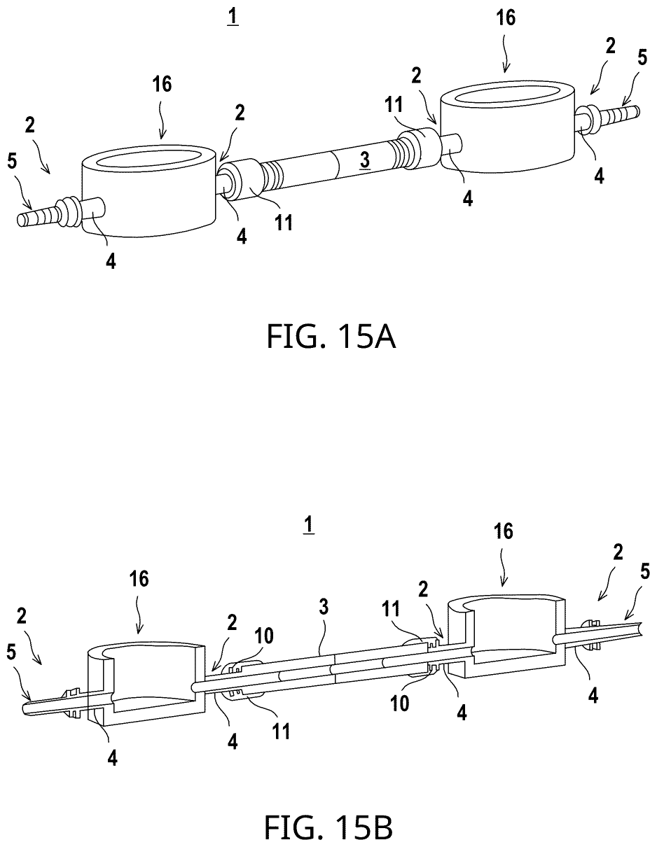

FIGS. 15A-B: Second exemplary embodiment of an arrangement with two connecting pieces on a hose in a perspective view and a sectional view.

FIGS. 1A-B show a first exemplary embodiment of the arrangement 1 according to the present disclosure.

The arrangement 1 according to FIGS. 1A-B and all other exemplary embodiments includes a connecting piece 2 and a hose 3. The hose 3 is advantageously formed as a multi-layer, kink-resistant hose 3. In all exemplary embodiments, the connecting piece 2 includes a connecting part 4 and a coupling part 5. A channel 6 runs through the entire connecting piece 2 in the longitudinal direction. The channel 6 is only shown in the coupling part 5. The connecting part 4 is not shown in a functional manner, in particular the channel 6 is not shown. The connecting part 4 can be formed by a plug, for example. The design of the coupling part 5, which is used to connect to the hose 3, is independent of the embodiment of the connecting part 4.

The coupling part 5 has an essentially hollow cylindrical shape.

There is a profiling on the outer jacket surface of the coupling part 5. The profiling has multiple ramp-shaped profile structures 7 arranged one behind the other at a spacing in the longitudinal direction of the coupling part 5. The inclines of the profile structure 7 at the end facing away from the connecting part 4 are flatter than at the end facing the connecting part 4.

In the present case, each profile structure 7 forms a structure which is closed in the circumferential direction.

A profile element 10, which is formed by a ring projecting upwards from the cylindrical jacket surface, adjoins the profiling in the direction of the connecting part 4. The profile element 10 extends over the entire circumference of the coupling part 5.

For fastening to the coupling part 5 of the connecting piece 2, the hose 3 is fitted onto the coupling part 5 with one lengthwise end by widening the hose, as shown in FIGS. 1A-B. The hose 3 is fitted onto the coupling part 5 to such an extent that the hose 3 completely covers the profiling and the channel segments 8 open out at the open end of the hose 3. However, the region of the coupling part 5 with the profile element 10 is not covered by the hose 3.

The profile structures of the profiling, due to their ramp structure, form a mechanical protection against detachment of the hose 3 from the coupling part 5.

Since the profile structures 7 of the profiling form closed elements in the circumferential direction, these also, to a certain extent, form barriers which prevent a gaseous or liquid medium from getting between the coupling part 5 and the hose 3 at its end face.

To fix the hose 3 to the coupling part 5, an overmolded mass 11 is overmolded in an injection molding method (FIGS. 1A-B). The overmolded mass 11 is formed from a thermoplastic. The overmolded mass 11 is overmolded onto the widened region of the hose 3, which region covers the profiling, and the adjacent, exposed region of the coupling part 5.

The overmolded mass 11 surrounds the annular profile element 10, whereby the overmolded mass 11 is mechanically fixed in position. The overmolded mass 11 ensures a stable connection between the hose 3 and the coupling part 5.

Since the overmolded mass 11 is in particular overmolded onto the end face of the hose 3 and the seam between the coupling part 5 and the hose 3 in the region of its end face, gaseous or liquid media are prevented from escaping there and in particular from penetrating between the layers of the multi-layer hose 3 due to creep effects. This prevents swelling of the hose 3 and thus impairment of the connection between the hose 3 and coupling part 5.

FIG. 2A shows the connecting piece 2 in a single view. FIG. 2B shows the connecting piece 2 with the overmolded mass 11 in a single view.

FIG. 3 shows the geometry of the body of the overmolded mass 11, which was overmolded onto the hose 3 and the coupling part 5, in a single view.

There is a cut-out 14 in the body of the overmolded mass 11, in which the profile element 10 is located.

FIGS. 4 to 7 show a second exemplary embodiment of the arrangement 1 according to the present disclosure.

This arrangement 1 differs from the arrangement 1 according to FIGS. 1 to 3 in that the profile structures 7 are perforated by channel segments 8 running in the longitudinal direction, as can be seen in particular in FIG. 5. At the rear end of the profiling, the channel segments 8 are connected by a further annular channel segment 9. The channel segments 8 thus form a contiguous channel structure.

The profile element 10, which is formed by a ring projecting upwards from the cylindrical jacket surface, again adjoins the profiling in the direction of the connecting part 4. The profile element 10 extends over the entire circumference of the coupling part 5.

For fastening to the coupling part 5 of the connecting piece 2, the hose 3 is again fitted onto the coupling part 5 with one lengthwise end by widening the hose, as shown in FIGS. 4A-B. The hose 3 is fitted onto the coupling part 5 to such an extent that the hose 3 completely covers the profiling and the channel segments 8 open out at the open end of the hose 3. However, the region of the coupling part 5 with the profile element 10 is not covered by the hose 3.

The profile structures of the profiling, due to their ramp structure, form a mechanical protection against detachment of the hose 3 from the coupling part 5.

To fix the hose 3 to the coupling part 5, an overmolded mass 11 is again overmolded in an injection molding method (FIGS. 4A, 1B). The overmolded mass 11 is overmolded onto the widened region of the hose 3, which region covers the profiling, and the adjacent, exposed region of the coupling part 5.

The overmolded mass 11 surrounds the annular profile element 10, whereby the overmolded mass 11 is mechanically fixed in position. The overmolded mass 11 ensures a stable connection between the hose 3 and the coupling part 5 and seals the seams between the hose 3 and the coupling part 5.

In this case, the overmolded mass 11 is not only overmolded onto the outside of the hose 3 and the coupling part 5. Rather, the overmolded mass 11 is also injected into the channel structure. Since the channel segments 8, 9 form a continuous channel structure, the overmolded mass 11 is injected into the entire channel structure. The overmolded mass 11 is introduced into the channel structure via the outlets of the channel segments 8 at the edge of the hose 3.

By injecting the overmolded mass 11 into the channel structure, the internal boundary surface between the coupling part 5 and the hose 3 is also sealed with the overmolded mass 11. This prevents the gaseous or liquid medium from escaping from the hose 3 due to creep effects.

FIG. 6 shows the geometry of the body of the overmolded mass 11, which was overmolded onto the hose 3 and the coupling part 5, in a single view. FIG. 7 shows the body of the overmolded mass 11 on the coupling part 5.

The body of the overmolded mass 11 has webs 12 running in the longitudinal direction of the coupling part 5, which are injected into the channel segments 8. Furthermore, the body has a ring segment 13, which is injected into the further channel segment 9. Furthermore, there is a cut-out 14 in the body of the overmolded mass 11, in which the profile element 10 is located.

FIGS. 8 to 10 show a further exemplary embodiment of the arrangement 1 according to the present disclosure. This arrangement 1 differs from the exemplary embodiment in FIGS. 4 to 7 only in terms of the design of the channel structure. In this case, the channel structure is formed by channel segments 8, which are connected by three further annular channel segments 9, wherein two of the channel segments 9 are located between adjacent profile structures 7.

FIGS. 11 to 13 show further variants of the coupling part 5 for the arrangement 1 according to the present disclosure.

The coupling parts 5 of FIGS. 11 to 13 differ from the exemplary embodiment of FIGS. 4 to 7 only with regard to the design of the profiling and thus with regard to the design of the channel structure.

In the embodiments shown in FIGS. 11 and 12, there are two channel segments 8, 8′running in the longitudinal direction of the coupling part 5 and arranged offset to each other, between which there is a further annular channel segment 9.

In the embodiment shown in FIG. 13, there is a profiling in the form of a spiral 15. The overmolded mass 11 is injected into the intermediate spaces of the spiral 15.

FIGS. 14A-B show a first exemplary embodiment of a further development of the arrangement 1 according to the present disclosure.

In the arrangement 1 according to FIGS. 14A-B, a connecting piece 2 is fixed to each end of the hose 3.

The coupling parts 5 of the connecting pieces 2 are identical and formed according to the embodiment of FIGS. 1A-B. The fastening of the coupling parts 5 of the connecting pieces 2 to the hose ends with the overmolded mass 11 also corresponds to the embodiment shown in FIGS. 1A-B.

As a result, each coupling part 5 has a profiling structure with ramp-shaped profile structures 7. There is also an annular profile element 10 on each coupling part 5.

To fix the coupling part 5 to the hose 3, the overmolded mass 11 is applied to the region of the coupling part 5 with the profile element 10 up to the hose 3, wherein the overmolded mass 11 also extends to the region of the hose 3 adjacent to the coupling part.

The connecting parts 4 of the connecting pieces 2 are also formed identically in the present case, although this is not mandatory.

The connecting parts 4 can be formed as components of plugs.

FIGS. 15A-B show a second exemplary embodiment of the further development of the arrangement 1 according to the present disclosure.

In the embodiment shown in FIGS. 15A-B, a connecting piece 2 is also fastened to each end of the hose 3.

The embodiment of FIGS. 15A-B differs from the arrangement 1 of FIGS. 14A-B only in that a component 16 is connected to each connecting piece 2. The component 16 can be formed as a valve or container, for example.

Each connecting piece 2 is firmly connected to the respective component 16 or is formed in one piece therewith.

The connecting pieces 2 and the components 16 are each formed identically, although this is not mandatory.

As FIGS. 15A-B show, a further connecting piece 2 opens out on the side of each component 16, which side is opposite the hose 3, which further connecting piece 2 has a structure identical to the connecting piece 2 on the opposite side. This allows a series arrangement with multiple components 16 to be formed, wherein two neighboring components 16 are each connected via a hose 3.

### List of Reference Signs

(1) Arrangement
(2) Connecting piece
(3) Hose
(4) Connecting part
(5) Coupling part
(6) Channel
(7) Profile structure
(8, 8′) Channel segment
(9) Channel segment
(10) Profile element
(11) Overmolded mass
(12) Web
(13) Ring segment
(14) Cut-out
(15) Spiral
(16) Component

What is claimed:

1. An arrangement with a connecting piece fastened to a hose, wherein the connecting piece has a coupling part partially inserted into the hose and a connecting part located outside the hose, comprising:
a profiling on the outer jacket surface of a first region of the coupling part, the first region is located in the hose; and
a profile element in a second region of the coupling part, the second region is located outside the hose,
wherein to fasten the connecting piece to the hose, there is an overmolded mass, which encloses the profile element in the second region of the coupling part and extends over a region of the hose which is adjacent thereto, wherein the overmolded mass is present on the outer jacket surface of the hose and on the end face thereof facing the profile element.

2. The arrangement according to claim 1, wherein the profile element is formed in the shape of an annular elevation.

3. The arrangement according to claim 1, wherein the profile element stabilizes the overmolded mass on the coupling part.

4. The arrangement according to claim 1, wherein the profiling of the coupling part has at least one profile structure forming an elevation, which profile structure effects a mechanical fixation of the hose.

5. The arrangement according to claim 4, wherein the profile structure is in the form of a ramp the incline of which, in the fitting direction of the hose, is smaller at the coupling part than in the opposite direction.

6. The arrangement according to claim 4, wherein the or each profile structure has a cross section that is uniform in a circumferential direction.

7. The arrangement according to claim 6, wherein each profile structure forms a structure which is closed in the circumferential direction.

8. The arrangement according to claim 1, wherein the profiling forms a continuous channel structure between the coupling part and the hose, which channel structure opens out at the edge of the hose, and in that overmolded mass is injected into the channel structure via the outlet at the edge of the hose.

9. The arrangement according to claim 8, wherein the channel structure has at least one channel segment running in a longitudinal direction of the coupling part, which channel segment opens out at the edge of the hose.

10. The arrangement according to claim 9, wherein the channel segment runs parallel to the longitudinal axis of the coupling part.

11. The arrangement according to claim 9, wherein at least one further channel segment running in a circumferential direction of the coupling part opens out at the channel segment running in the longitudinal direction.

12. The arrangement according to claim 11, wherein the further channel segment is formed in an annular shape.

13. The arrangement according to claim 1, wherein the overmolded mass is applied to the coupling part and the hose in an injection molding method.

14. The arrangement according to claim 1, wherein the overmolded mass is a thermoplastic.

15. The arrangement according to claim 1, wherein the connecting piece has a channel running through it in a longitudinal direction, the diameter of which is at least approximately equal to the internal diameter of the hose.

16. The arrangement according to claim 1, wherein the hose is fitted onto the coupling part by widening it.

17. The arrangement according to claim 1, wherein the hose is a multi-layer hose.

18. The arrangement according to claim 17, wherein the multi-layer hose is fitted onto the coupling part in such a way that its inner layer, which lies directly on the coupling part, projects beyond the edge of the hose and is overmolded with the overmolded mass.

19. The arrangement according to claim 18, wherein a connecting piece is fastened to both ends of the hose.

20. The arrangement according to claim 19, wherein a component is present on one or on each connecting piece.
